(19) United States
(12) Patent Application Publication
(10) Pub. No.: US 2016/0116870 A1
(43) Pub. Date: Apr. 28, 2016

(54) IMAGE FORMING APPARATUS

(71) Applicant: KYOCERA Document Solutions Inc., Osaka (JP)

(72) Inventor: Kazunori Tanaka, Osaka (JP)

(21) Appl. No.: 14/918,609

(22) Filed: Oct. 21, 2015

(30) Foreign Application Priority Data
Oct. 24, 2014 (JP) 2014-217243

(51) Int. Cl. G03G 15/20; G03G 15/00

(52) U.S. Cl. CPC G03G 15/2039; G03G 15/6585

(57) ABSTRACT

An image forming apparatus includes an image forming unit, a fixing device, a degree-of-glossiness input unit, and a control unit. The image forming unit includes a developing device configured to perform development to form, on the basis of image data, a visible image of a toner on paper. The fixing device includes a pair of rollers that contact each other, conveys the paper by the image forming unit to between the pair of rollers, fixes the visible image on the paper by heat and pressure, and outputs the paper as an output material. The degree-of-glossiness input unit causes a user to input the degree of glossiness of the output material. The control unit controls at least one of the fixing device and the image forming unit to change the degree of glossiness of the output material in accordance with the degree of glossiness of the output material.

### INCORPORATION BY REFERENCE

The disclosure of Japanese Patent Application No. 2014-217243 filed on Oct. 24, 2014, including the specification, drawings and abstract is incorporated herein by reference in its entirety.

### BACKGROUND

This disclosure relates to an image forming apparatus.

In an image forming apparatus, which is typified by a digital multifunction peripheral and the like, an image of an original document is read out by an image reading unit, and then, a photoreceptor provided to an image forming unit is irradiated with light on the basis of the readout image to form an electrostatic latent image on the photoreceptor. Thereafter, a charged toner is fed from a developing apparatus onto the formed electrostatic latent image to form a visible image, the visible image is transferred and fixed onto a paper, which has been fed, and then, the paper is discharged to the outside of the apparatus.

Techniques related to the glossiness of a photo image in forming an image have been conventionally known.

Conventionally, there has been known an image forming apparatus configured such that a graphics region and a text region in image information are determined, the graphic region is developed by a developing device configured to form an image having a high glossiness, and the text region is developed by a developing device configured to from an image having a low glossiness.

Conventionally, there has been known another image forming apparatus which includes a fixing device configured to fix an unfixed toner image formed on a transfer material by an image forming unit by pressing and heating, and is characterized by including an identification unit configured to identify first image information corresponding to a photo image from image information input to the image forming apparatus and second image information corresponding to a text image from each other, and in that, after an unfixed toner image based on the first image information is formed on a transfer material and is fixed by the fixing device, an unfixed toner image based on the second image information is formed on the transfer material and is fixed by the fixing device.

Conventionally, there has been known still another image forming apparatus which includes a fixing device configured to fix a toner image on a printing medium and a driving source configured to drive the fixing device and be capable of switching the driving speed thereof in a stepless manner, and is characterized by including a printing mode switching unit configured to perform switching between a normal mode and a gloss mode in accordance with a printing mode and a detection unit configured to detect a density distribution of a toner image of the printing medium in a vertical scanning direction, and in that, when the gloss mode is selected, the driving speed of the driving source that drives the fixing device is determined on the basis of the detected density distribution.

### SUMMARY

According to an aspect of the present disclosure, an image forming apparatus includes an image forming unit, a fixing device, a degree-of-glossiness input unit, and a control unit. The image forming unit includes a developing device configured to perform development to form, on the basis of image data, a visible image of a toner on a sheet of paper. The fixing device includes a pair of rollers that contact each other. The fixing device conveys the sheet of paper on which the visible image is formed by the image forming unit to between the pair of rollers, fixes the visible image on the paper by heat and pressure, and outputs the sheet of paper as an output material. The degree-of-glossiness input unit causes the user input the degree of glossiness of the output material. The control unit controls at least one of the fixing device and the image forming unit to change the degree of glossiness of the output material in accordance with the degree of glossiness of the output material, which was input by the degree-of-glossiness input unit.

### BRIEF DESCRIPTION OF THE DRAWINGS

FIG. 1 is a schematic view illustrating an outer appearance of a digital multifunction peripheral achieved by applying an image forming apparatus according to an embodiment of the present disclosure to a digital multifunction peripheral.

FIG. 2 is a block diagram illustrating a configuration of the digital multifunction peripheral achieved by applying an image forming apparatus according to the embodiment to a digital multifunction peripheral.

FIG. 3 is an outside view illustrating a schematic configuration of an operation unit.

FIG. 4 is an outside view illustrating a schematic configuration of an image forming unit.

FIG. 5 is a flow chart illustrating contents of processing performed when an image of a document is read out and copying is performed using the digital multifunction peripheral.

FIG. 6 is a view illustrating an example of a display screen of the operation unit when making the user select image quality of an image of a document in image forming

FIG. 7 is a view illustrating an example of the display screen of the operation unit when making the user select the presence or absence of glossiness in a photo image.

FIG. 8 is a view schematically illustrating a document formed by an image including a text image and a photo image in a mixed manner.

FIG. 9 is a graph illustrating the relationship between the desirability of the degree of glossiness required by a user and the degree of glossiness.

FIG. 10 is a flow chart illustrating contents of processing performed when performing copying using a digital multifunction peripheral according to another embodiment of the present disclosure.

FIG. 11 is a view illustrating an example of a display screen of the operation unit when urging the user to set various settings in image forming

FIG. 12 is a view illustrating an example of the display screen of the operation unit when making the user set the gloss mode.

FIG. 13 is a view illustrating an example of the display screen when the image of the document illustrated in FIG. 8 has been read out and previewed.

FIG. 14 is a view illustrating an image of a document in which an area of a photo image is large, as compared to the image of the document illustrated in FIG. 8.

### DETAILED DESCRIPTION

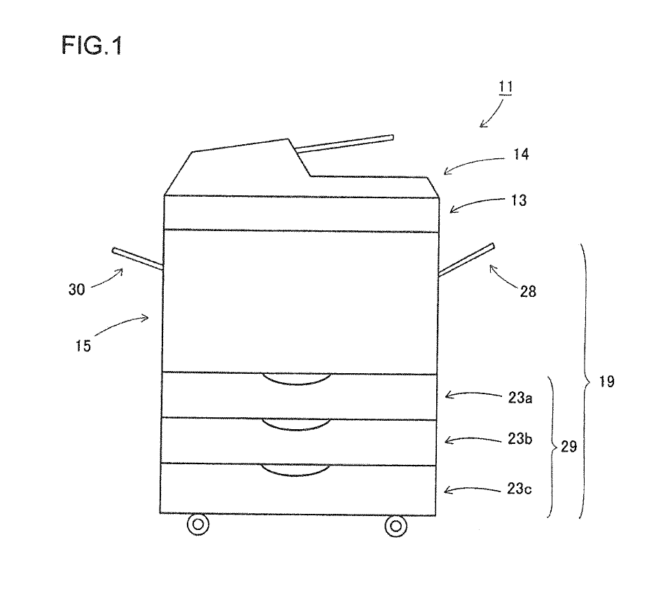

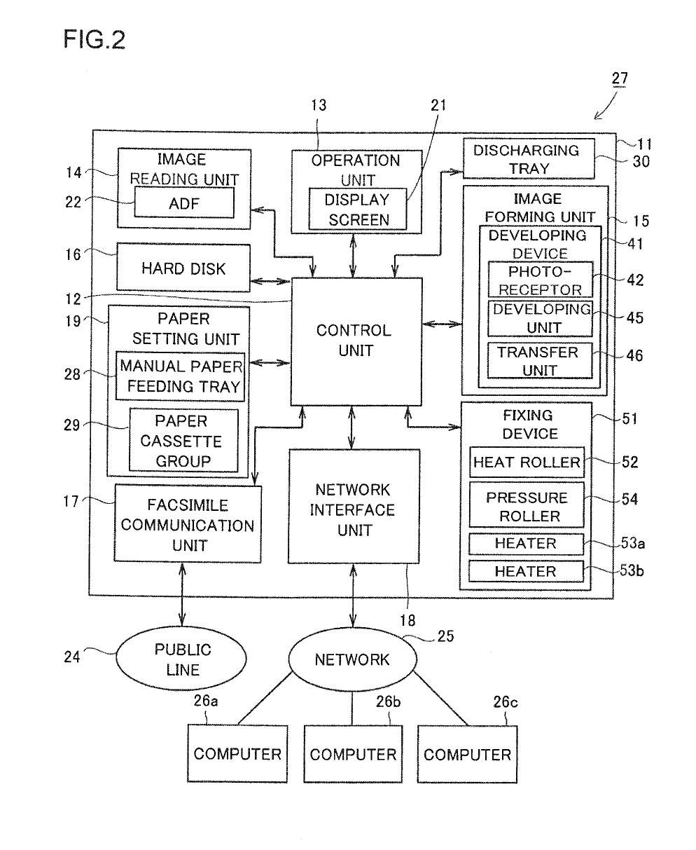

Embodiments of the present disclosure will be described below. First, a configuration of a digital multifunction peripheral achieved by applying an image forming apparatus according to an embodiment of the present disclosure to a digital multifunction peripheral will be described. FIG. 1 is a schematic view illustrating an outer appearance of the digital multifunction peripheral achieved by applying an image forming apparatus according to the embodiment of the present disclosure to a digital multifunction peripheral. FIG. 2 is a block diagram illustrating a configuration of the digital multifunction peripheral achieved by applying an image forming apparatus according to the embodiment to a digital multifunction peripheral.

With reference to FIG. 1 and FIG. 2, a digital multifunction peripheral 11 includes a control unit 12, an operation unit 13, an image reading unit 14, a paper setting unit 19, an image forming unit 15, a discharging try 30, a hard disk 16, a facsimile communication unit 17, and a network interface unit 18 configured to provide a connection with a network 25. The control unit 12 performs control of the entire digital multifunction peripheral 11. The operation unit 13 includes a display screen 21 configured to display information sent from the digital multifunction peripheral 11 side and input contents of a user. The operation unit 13 causes the user input conditions, such as the number of print copies, gradation, and the like, for image forming, and on and off of a power supply source. The image reading unit 14 includes an auto document feeder (ADF) 22 configured to automatically convey a document, which has been set, to a reading unit. The image reading unit 14 reads out an image of the document. The paper setting unit 19 includes a manual paper feeding tray 28 in which paper is manually set and a paper cassette group 29 that is capable of storing a plurality of sheets of paper with different sizes. In the paper setting unit 19, paper that is fed to the image forming unit 15 is set. The image forming unit 15 includes a developing device 41 configured to form a visible image by a toner on a sheet of paper on the basis of a readout image and image data transmitted via the network 25 and perform development, and forms an image. A fixing device 51 fixes the visible image on the sheet of paper by heat and pressure and outputs the sheet of paper as an output material. The discharging try 30 discharges the sheet of paper after an image is formed on the sheet of paper by the image forming unit 15. The hard disk 16 stores transmitted image data, input image forming conditions, and the like. The facsimile communication unit 17 is coupled to a public line 24 and performs facsimile transmission and facsimile reception. Note that the digital multifunction peripheral 11 includes a dynamic random access memory (DRAM), and the like, to and from which image data is written and read, but the illustration and description of them will be omitted. In FIG. 2, arrows indicate flows of data regarding a control signal, control, and an image. Note that, as illustrated in FIG. 1, in this embodiment, the paper cassette group 29 includes three paper cassettes 23a, 23b, and 23c.

The digital multifunction peripheral 11 forms an image in the image forming unit 15 using a document read by the image reading unit 14, and thus, operates as a copy machine. The digital multifunction peripheral 11 forms an image in the image forming unit 15 using image data transmitted from computers 26a, 26b, and 26c coupled to the network 25 via the network interface unit 18 to print the formed image on a sheet of paper, and thus, operates as a printer. That is, the image forming unit 15 operates as a print unit that prints a requested image. The digital multifunction peripheral 11 forms an image in the image forming unit 15 via the DRAM using image data transmitted from the public line 24 via the facsimile communication unit 17, or transmits image data of a document read by the image reading unit 14 to the public line 24 via the facsimile communication unit 17, and thus, operates as a facsimile apparatus. That is, the digital multifunction peripheral 11 has a plurality of functions, such as a copy function, a printer function, a facsimile function, and the like, for image processing. Furthermore, for each function, a function that may be set in detail is provided.

An image forming system 27 according to this embodiment, which includes the image forming apparatus 11, includes the digital multifunction peripheral 11 and the plurality of computers 26a, 26b, and 26c. Specifically, the image forming system 27 includes the digital multifunction peripheral 11 having the above-described configuration, the plurality of computers 26a, 26b, and 26c coupled to the digital multifunction peripheral 11 via the network 25. In this embodiment, as the plurality of computers 26a, 26b, and 26c, three computers are illustrated. Each of the computers 26a, 26b, and 26c is capable of making a print request to the digital multifunction peripheral 11 via the network 25 to perform printing. The digital multifunction peripheral 11 and the computers 26a, 26b, and 26c may be coupled to one another via a wire using a local area network (LAN) cable, or the like, and also, may be wirelessly coupled to one another, and a configuration in which another digital multifunction peripheral and a server are coupled in the network 25 may be also employed.

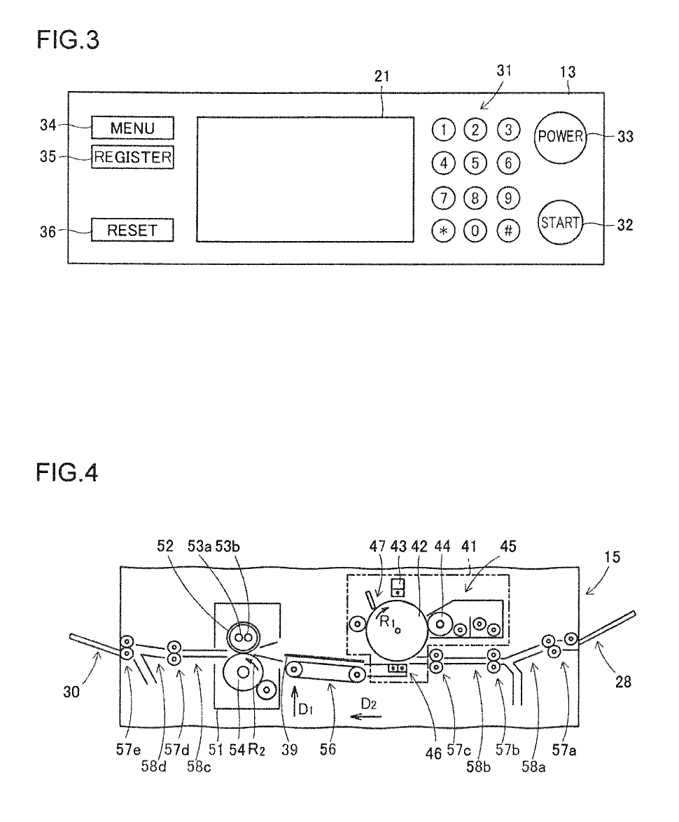

Next, a configuration of the above-described operation unit 13 will be described further in detail. FIG. 3 is an outside view illustrating a schematic configuration of the operation unit 13. With reference to FIG. 3, the operation unit 13 includes a numeric keypad 31 used by the user to input numbers 0 to 9 and symbols, such as “*” and “#”, used by the user to input the number of print copies and the like, a start key 32 used by the user to instruct a start of printing and a start of facsimile transmission, a power key 33 used by the user to input on and off of power of the digital multifunction peripheral 11, a menu key 34 used by the user to instruct selection of a printer function, a copy function, or the like, of the digital multifunction peripheral 11, a register key 35 used by the user to instruct various image forming conditions and user registration, a reset key 36 used by the user to cancel contents of an instruction input by the user using the numeric keypad 31 or the like, and the above-described display screen 21. The display screen 21 includes a liquid crystal touch panel function and allows the user to select a function and the like from the display screen 21 as well as input image forming conditions and the like by pressing thereon with a finger of the user or the like.

Next, configurations of the image forming unit 15 and the fixing device 51 included in the digital multifunction peripheral 11 will be described further in detail. FIG. 4 is a cross-sectional view illustrating a schematic configuration of a digital multifunction peripheral according to an embodiment of the present disclosure. Note that, in order to facilitate understanding, in FIG. 4, hatching of members is omitted. Also, FIG. 4 is a cross-sectional view of the digital multifunction peripheral 11, taken along a plane extending in the vertical direction, assuming that the digital multifunction peripheral 11 is cut along the plane.

With reference to FIG. 4, the image forming unit 15 includes the developing device 41 configured to form a visible image on a sheet of paper using a developer, such as a toner, and the like. The developing device 41 indicated by the alternate long and two short dashes line in FIG. 4 includes a photoreceptor 42 configured to form an electrostatic latent image on a surface thereof, a charging unit 43 configured to charge the surface of the photoreceptor 42, a developing unit 45 that includes a developing sleeve 44 and a plurality of agitating rollers and is configured to feed a developer, such as a toner, and the like, onto a surface of the photoreceptor 42 on which an electrostatic latent image is formed and to thus form a visible image of the toner, a transfer unit 46 that includes a transfer charger and a separation charger and is configured to transfer the visible image formed on the surface of the photoreceptor 42 to a sheet of paper 39, which has been conveyed, and a cleaning unit 47 that includes a discharging roller, a cleaning blade, and the like, and is configured to remove the toner, residual electric charges, and the like, which remain on the surface of the photoreceptor 42 after the transfer of the visible image to the sheet of paper 39.

The photoreceptor 42 rotates in the direction of an arrow R1 in FIG. 4. The image forming unit 15 forms an electrostatic latent image on the photoreceptor 42 on the basis of image read by the image reading unit 14 and image data transmitted from the computers 26a, 26b, and 26c. The image forming unit 15 feeds a toner to the electrostatic latent image formed on the photoreceptor 42 to form a visible image of the toner. In developing, a developing bias voltage of a predetermined value is applied to the developing sleeve 44. Then, due to a potential difference between a surface potential of the photoreceptor 42 charged by the charging unit 43 and the developing bias voltage, the toner is moved from the developing sleeve 44 side onto a part of the surface of the photoreceptor 42 on which the electrostatic latent image is formed to which the toner is to be supposed to be moved. The image forming unit 15 repeatedly performs charging, developing, transferring, and cleaning on the photoreceptor 42 to form a visible image of the toner on the sheet of paper 39, which has been conveyed. Note that an amount of the toner corresponding to the amount of the toner consumed by developing is fed to the developing unit 45 at all times by a toner container (not illustrated) attachably and removably provided in the developing device 41.

The digital multifunction peripheral 11 includes the fixing device 51 configured to fix the visible image formed on the sheet of paper 39 by the developing device 41. The fixing device 51 includes, as a pair of rollers, a hollow, rotatable heat roller 52 configured to heat a sheet of paper when the toner is fixed to the sheet of the paper and a solid, rotatable pressure roller 54 configured to apply pressure to the sheet of paper when the toner is fixed on the sheet of paper.

The heat roller 52 has a cylindrical shape, and is formed by a metal element pipe. A pair of heaters 53a and 53b is provided inside the heat roller 52. The heaters 53a and 53b are energized, and thus, the heat roller 52 is heated to a predetermined temperature that is suitable for fixing. The control unit 12 controls energized states of the heaters 53a and 53b to control the temperature of the heat roller 52.

The pressure roller 54 is formed by a rubber cylindrical member having elasticity. The heat roller 52 and the pressure roller 54 contact each other. Specifically, the heat roller 52 and the pressure roller 54 are provided such that a surface of the heat roller 52 and a surface of the pressure roller 54 contact each other in a certain area. Note that, since the heat roller 52 and the pressure roller 54 contact each other, the heat of the heat roller 52 is transferred to the pressure roller 54 to a certain extent. That is, the heat roller 52 and the pressure roller 54 have substantially the same temperature. Note that the pressure roller 54 is formed so as to have a crowning shape in which the diameter thereof is slightly greater in a central portion thereof than in both end portions thereof.

The pressure roller 54 may slightly increase pressing force applied to the heat roller 52 in an upward direction of the digital multifunction peripheral 11, indicated by an arrow D1 in FIG. 4. Due to this increase in pressing force, an area of contact of the heat roller 52 and the pressure roller 54 and a pressure of the contact may be increased. Pressed states of the heat roller 52 and the pressure roller 54 are controlled by the control unit 12.

The pressure roller 54 rotates in the direction of an arrow R2 in FIG. 4. The heat roller 52 rotates in an opposite direction to the direction in which the pressure roller 54 rotates. The sheet of paper 39 is conveyed from an upstream side, that is, a side in which the image forming unit 15 is provided, to a downstream side, that is, a side in which the discharging try 30 is provided. In this conveying, fixing of the visible image formed on the sheet of paper 39 by heat and pressure is performed. The direction in which the sheet of paper 39 is conveyed is roughly indicated by an arrow D2 in FIG. 4. Note that rotation speeds of the heat roller 52 and the pressure roller 54 are also controlled by the control unit 12.

In this case, in fixing, two stages are provided for each of the temperatures of the heat roller 52 and the pressure roller 54, the rotation speeds of the heat roller 52 and the pressure roller 54, the pressure of contact of the heat roller 52 and the pressure roller 54. As for the temperatures of the heat roller 52 and the pressure roller 54, two-stage setting is possible, that is, each of the temperatures of the heat roller 52 and the pressure roller 54 may be set to a first temperature, which is the standard temperature, and a second temperature, which is slightly higher than the first temperature. The degree of glossiness of an achieved image may be made higher when fixing is performed at the second temperature than when fixing is performed at the first temperature. As for the rotation speeds of the heat roller 52 and the pressure roller 54, two-stage setting is possible, that is, each of the rotation speeds of the heat roller 52 and the pressure roller 54 may be set to a first rotation speed, which is the standard rotation speed, and a second rotation speed, which is slightly lower than the first rotation speed. The degree of glossiness of an achieved image may be made higher when fixing is performed at the second rotation speed than when fixing is performed at the first rotation speed. As for the pressure of contact of the heat roller 52 and the pressure roller 54, two-stage setting is possible, that is, the pressure of contact of the heat roller 52 and the pressure roller 54 may be set to a first pressure, which is the standard pressure, and a second pressure, which is slightly higher than the first pressure. The degree of glossiness of an achieved image may be made higher when fixing is performed at the second pressure than when fixing is performed at the first pressure. In fixing, the fixing device 51 sets each of the temperatures, the rotation speeds, and the pressure to the corresponding one of the settings, and performs fixing. As a matter of course, in any one of the settings, the degree of glossiness in an output material merely differs, but proper fixing may be performed. Note that, the above-described control is performed by control of a so-called engine (not illustrated) included in the digital multifunction peripheral 11.

Note that, in this embodiment, the parameters are set such that the degree of glossiness of the output material may be increased in accordance with the order of the temperatures of the heat roller 52 and the pressure roller 54, the rotation speeds of the heat roller 52 and the pressure roller 54, and the pressure of contact of the heat roller 52 and the pressure roller 54. That is, an influence of the temperatures of the heat roller 52 and the pressure roller 54 is the greatest in increasing the degree of glossiness of the output material, the influence in increasing the degree of glossiness of the output material reduces in the order of the rotation speeds of the heat roller 52 and the pressure roller 54 and the pressure of contact of the heat roller 52 and the pressure roller 54. Note that the order of the parameters that increase the degree of glossiness of the output material may change from the above-described order, depending on setting, an apparatus configuration, and the like. That is, in another embodiment, for example, the parameters may be set such that the degree of glossiness of the output material may be increased in accordance with the order of the rotation speeds of the heat roller 52 and the pressure roller 54, the pressure of contact of the heat roller 52 and the pressure roller 54, and the temperatures of the heat roller 52 and the pressure roller 54.

Note that the image forming unit 15 includes a conveying belt 56 provided between the developing device 41 and the fixing device 51, and a plurality of paper feeding rollers 57a, 57b, 57c, 57d, and 57e. For example, the sheet of paper 39 set in the manual paper feeding tray 28 is conveyed through paper conveyance paths 58a, 58b, 58c, and 58d by the paper feeding rollers 57a, 57b, 57c, 57d, and 57e, and is discharged to the discharging try 30. Also, the sheet of paper 39 set in the paper cassettes 23a, 23b, and 23c is conveyed to the paper conveyance paths 58b, 58c, and 58d by the paper feeding rollers 57b, 57c, 57d, and 57e, and is discharged to the discharging try 30.

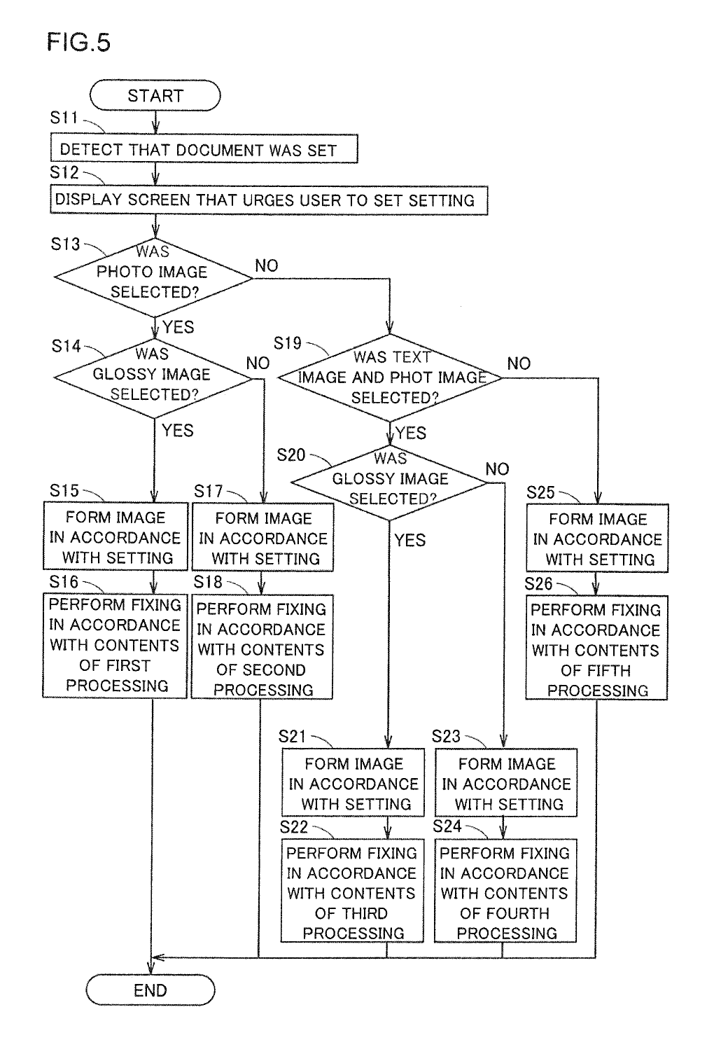

Next, a case where, using the above-described digital multifunction peripheral 11, an image is formed, that is, specifically, a case where, using the digital multifunction peripheral 11, an image of a document set in the ADF 22 is read out and duplication, that is, copying is performed, will be described. FIG. 5 is a flow chart illustrating contents of processing performed when the image of the document is read out and copying is performed using the digital multifunction peripheral 11. First, a case where the image of the document set in the ADF 22 includes only a photo image will be described.

With reference to FIG. 5, first, a user sets a document in the ADF 22. When the digital multifunction peripheral 11 detects that the document was set in the ADF 22 (Step S11 in FIG. 5, and “Step” will be hereinafter will be omitted), the digital multifunction peripheral 11 displays a screen that urges the user to set various settings in image forming in the display screen 21 of the operation unit 13 (S12). Then, as one of the various settings in image forming, the display screen 21 causes the user to select image quality of the image of the document is caused to be displayed.

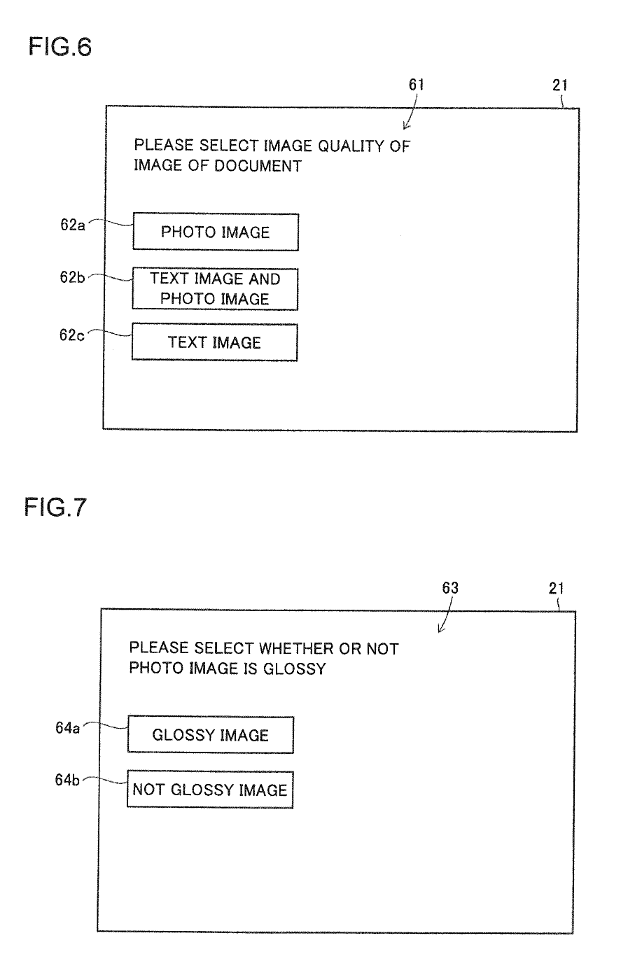

FIG. 6 is a view illustrating an example of the display screen 21 of the operation unit 13 when making the user to select the image quality of the image of the document in image forming With reference to FIG. 6, a message 61 indicating “PLEASE SELECT IMAGE QUALITY OF IMAGE OF DOCUMENT”, a selection key 62a that indicates “PHOTO IMAGE” and is used by the user to set a photo image for the quality of the image of the document, a selection key 62b that indicates “TEXT IMAGE AND PHOTO IMAGE” and is used by the user to set an image including a photo image and a text image in a mixed manner for the quality of the image of the document, and a selection key 62c that indicates “TEXT IMAGE” and is used by the user to set a text image for the quality of the image of the document are displayed in the display screen 21. In this case, the operation unit 13 and the like operate as a setting unit that causes the user to set information on which one of a photo image, a text image, and an image including a text image and a photo image in a mixed manner the image data is.

In this case, when the user recognizes that the image of the document set in the ADF 22 includes only a photo image, the user presses down the selection key 62a that is used by the user to set “PHOTO IMAGE”. When the digital multifunction peripheral 11 detects that the selection key 62a was pressed down, the digital multifunction peripheral 11 recognizes that a photo image was selected (YES in S13).

Next, the digital multifunction peripheral 11 causes the user to set, for the photo image of the document, whether or not the photo image is glossy, that is, the presence or absence of glossiness in the photo image, in the display screen 21 of the operation unit 13. In this case, the operation unit 13 and the like operate as a degree-of-glossiness input unit that causes the user to input the degree of glossiness of an output material. In general, the user desires a faithfully reproduced output material of the photo image in the image of the document, which is a duplicate in this case. In this case, if the photo image in the image of the document is glossy, the user requests a high degree of glossiness for a photo image of the duplicate, which is the output material, and if the photo image in the image of the document is not glossy, the user requests a low degree of glossiness for the photo image of the duplicate. The user sets the degree of glossiness for the photo image of the document, on the basis of a desire of the user.

FIG. 7 is a view illustrating an example of the display screen 21 of the operation unit 13 when making the user to set the presence or absence of glossiness in a photo image. With reference to FIG. 7, a message 63 indicating “PLEASE SELECT WHETHER OR NOT PHOTO IMAGE IS GLOSSY”, a selection key 64a that indicates “GLOSSY IMAGE” and is used by the user to set a glossy photo image, and a selection key 64b that indicates “NOT GLOSSY IMAGE” and is used by the user to set a not glossy image are displayed in the display screen 21. In this case, the operation unit 13 and the like operate as a glossy-or-not input unit that causes the user to input the presence or absence of glossiness.

When the user determines that the photo image in the image of the document is glossy, the user presses down the selection key 64a that is used by the user to set “GLOSSY IMAGE”. When the digital multifunction peripheral 11 detects that the selection key 64a was pressed down, the digital multifunction peripheral 11 recognizes that “GLOSSY IMAGE” was selected (YES in S14).

Thereafter, that is, after setting is completed, the user presses down a start key 32 of the operation unit 13. After detecting that the start key 32 was pressed down, the digital multifunction peripheral 11 reads out the image of the document set in the ADF 22 by the image reading unit 14. Then, on the basis of the readout image, the digital multifunction peripheral 11 forms a visible image of the toner on the sheet of paper 39 by the image forming unit 15 in accordance with settings set by the operation unit 13 (S15).

Thereafter, the visible image of the toner is fixed on the sheet of paper 39 by the fixing device 51, and the sheet of paper 39 is discharged to the discharging try 30. In this case, the above-described fixing by the fixing device 51 is performed in accordance with contents of first processing considering the degree of glossiness that has been set (S16). Specifically, each of the temperatures of the heat roller 52 and the pressure roller 54 is set to the second temperature, which is slightly higher than the first temperature, which is the standard temperature. Each of the rotation speeds of the heat roller 52 and the pressure roller 54 is set to the second rotation speed, which is slightly lower than the first rotation speed, which is the standard setting. The pressure of contact of the heat roller 52 and the pressure roller 54 is set to the second pressure, which is slightly higher than the first pressure, which is the standard pressure. Thus, control of the fixing device 51 is performed and fixing is performed.

By performing fixing in accordance with the above-described contents of the first processing, the temperature of fixing is set to be slightly higher than the standard temperature, each of the rotation speeds of the heat roller 52 and the pressure roller 54 is set to be slightly lower than the standard rotation speed, and the pressure of contact of the heat roller 52 and the pressure roller 54 is set to be slightly higher than the standard pressure, so that, for the achieved photo image, the high degree of glossiness may be increased. That is, when the image of the document is a photo image and is glossy, a faithfully reproduced duplication of the image of the document having the same degree of glossiness may be achieved.

Next, a case where the image of the document is a photo image and is not glossy will be described. Returning to FIG. 5, when the digital multifunction peripheral 11 detects that the selection key 62a was pressed down, the digital multifunction peripheral 11 recognizes that a photo image was selected (YES in S13). Next, the digital multifunction peripheral 11 causes the user to set, for the photo image of the document, whether or not the photo image is glossy, that is, the presence or absence of glossiness in the photo image, in the display screen 21.

In this case, if the user determines that the photo image of the document is glossy, the user presses down the selection key 64b that is used by the user to set “NOT GLOSSY IMAGE”. When the digital multifunction peripheral 11 detects that the selection key 64b was pressed down, the digital multifunction peripheral 11 recognizes that “NOT GLOSSY IMAGE” was set (NO in S14). Next, in a similar manner to the manner described above, after detecting that the start key 32 was pressed down, the digital multifunction peripheral 11 reads out the image of the document set in the ADF 22 by the image reading unit 14. Then, on the basis of the readout image, the digital multifunction peripheral 11 forms a visible image of the toner on a sheet of paper by the image forming unit 15 (S17).

Thereafter, the visible image of the toner is fixed on the sheet of paper by the fixing device 51, and the sheet of paper is discharged to the discharging try 30. In this case, the above-described fixing by the fixing device 51 is performed in accordance with contents of second processing considering the degree of glossiness that has been set (S18). The second processing is processing of increasing the degree of glossiness to a degree that is lower than that in the first processing but is higher than that when a text image is formed and fixed. Specifically, each of the temperatures of the heat roller 52 and the pressure roller 54 is set to the first temperature, which is the standard temperature. Each of the rotation speeds of the heat roller 52 and the pressure roller 54 is set to the second rotation speed, which is slightly lower than the standard setting. The pressure of contact of the pressure roller 54 and the heat roller 52 is set to the second pressure, which is slightly higher than the standard pressure. Thus, control of the fixing device 51 is performed and fixing is performed.

By performing fixing in accordance with the above-described contents of the second processing, a photo image having a low degree of glossiness may be achieved. That is, when the image of the document is a photo image and is not glossy, a faithfully reproduced duplication of the image of the document having the same degree of glossiness may be achieved.

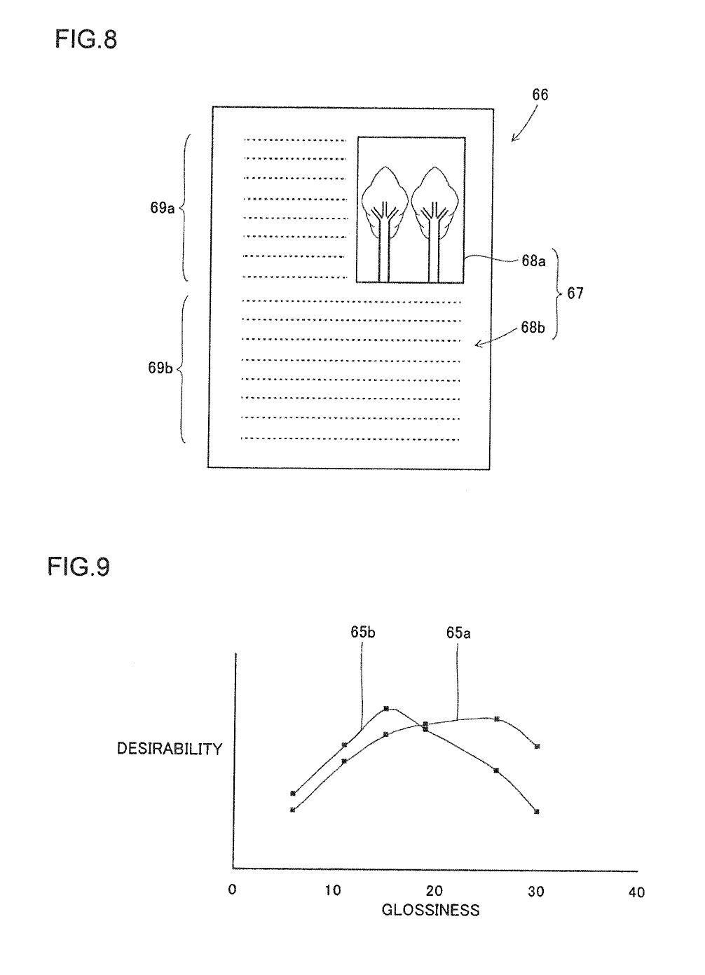

Next, a case where the document set in the ADF 22 is an image including a text image and a photo image in a mixed manner will be described. FIG. 8 is a view schematically illustrating a document formed by an image including a text image and a photo image in a mixed manner. With reference to FIG. 8, an image 67 of a document 66 includes a photo image 68a that occupies the upper right one of four regions into which a paper surface is divided vertically and horizontally and a text image 68b that occupies the other areas than the photo image 68a. There are a case where the photo image 68a is glossy and a case where the photo image 68a is not glossy.

Returning to FIG. 5, the user recognizes that the image 67 of the document 66 illustrated in FIG. 8, which is set in ADF 22, is formed by an image including the text image 68b and the photo image 68a in mixed manner, and presses down the selection key 62b, which is used by the user to set “TEXT IMAGE AND PHOTO IMAGE”. When the digital multifunction peripheral 11 detects that the selection key 62b was pressed down, the digital multifunction peripheral 11 recognizes that a mode of an image including a text image and a photo image in a mixed manner was selected (NO in S13, YES in S19). Next, the digital multifunction peripheral 11 causes the user to set whether or not the photo image 68a that forms a part of the image 67 of the document 66 is glossy, that is, the presence or absence of glossiness in the photo image 68a, in the display screen 21.

If the user determines that the photo image 68a is glossy, the user presses down the selection key 64a, which is used by the user to set “GLOSSY IMAGE”. When the digital multifunction peripheral 11 detects that the selection key 64a was pressed down, the digital multifunction peripheral 11 recognizes that “GLOSSY IMAGE” was set (YES in S20). Thereafter, in a similar manner to the manner described above, after detecting that the start key 32 was pressed down, the digital multifunction peripheral 11 reads out the image of the document set in the ADF 22 by the image reading unit 14. Then, on the basis of the readout image, the digital multifunction peripheral 11 forms a visible image of the toner on the sheet of paper 39 by the image forming unit 15 (S21).

Thereafter, the visible image of the toner is fixed on the sheet of paper 39 by the fixing device 51, and the sheet of paper 39 is discharged to the discharging try 30. In this case, the above-described fixing by the fixing device 51 is performed in accordance with contents of third processing considering the degree of glossiness that has been set (S22). The third processing is processing of increasing the degree of glossiness to a degree that is lower than that in the first processing but is higher than that in the second processing. Specifically, each of the temperatures of the heat roller 52 and the pressure roller 54 is set to the second temperature, which is slightly higher than the standard temperature. Each of the rotation speeds of the heat roller 52 and the pressure roller 54 is set to the first rotation speed, which is the standard setting. The pressure of contact of the pressure roller 54 and the heat roller 52 is set to the second pressure, which is slightly higher than the standard pressure. Thus, control of the fixing device 51 is performed, and fixing is performed.

By performing the above-described contents of the third processing, in an image including a text image and a photo image in a mixed manner, an image including a photo image having a slightly high degree of glossiness may be achieved. That is, when the image of the document is an image including a text image and a photo image in a mixed manner and a region of the photo image of the document is glossy, a duplication of the image of the document in which the degree of glossiness of the text image has not been increased so much and the degree of glossiness of the photo image has been increased to a slightly high degree may be achieved.

Next, a case where the document set in the ADF 22 is the image of FIG. 8, including a text image and a photo image in a mixed manner, and the photo image is not glossy will be described.

Returning to FIG. 5, when the digital multifunction peripheral 11 detects that the selection key 62b was pressed down, the digital multifunction peripheral 11 recognizes that a mode of an image including a text image and a photo image in a mixed manner was selected (NO in S13, YES in S19). Next, the digital multifunction peripheral 11 causes the user to set the presence or absence of glossiness in the photo image 68a.

In this case, if the user determines that the photo image 68a is not glossy, the user presses down the selection key 64b, which is used by the user to set “NOT GLOSSY IMAGE”. When the digital multifunction peripheral 11 detects that the selection key 64b was pressed down, the digital multifunction peripheral 11 recognizes that “NOT GLOSSY IMAGE” was set (NO in S20). Thereafter, in a similar manner to the manner described above, after detecting that the start key 32 was pressed down, the digital multifunction peripheral 11 reads out the image of the document set in the ADF 22 by the image reading unit 14. Then, on the basis of the readout image, the digital multifunction peripheral 11 forms a visible image of the toner on the sheet of paper 39 by the image forming unit 15 (S23).

Thereafter, the visible image of the toner is fixed on the sheet of paper by the fixing device 51, and the sheet of paper 39 is discharged to the discharging try 30. In this case, the above-described fixing by the fixing device 51 is performed in accordance with contents of fourth processing considering the degree of glossiness that has been set (S24). The fourth processing is processing of increasing the degree of glossiness to a degree that is lower than that in the third processing but is higher than that when a text image is formed and fixed. Specifically, each of the temperatures of the heat roller 52 and the pressure roller 54 is set to the first temperature, which is the standard temperature. Each of the rotation speeds of the heat roller 52 and the pressure roller 54 is set to the first rotation speed, which is the standard setting. The pressure of contact of the pressure roller 54 and the heat roller 52 is set to the second pressure, which is slightly higher than the standard pressure. Thus, control of the fixing device 51 is performed, and fixing is performed.

By performing the above-described contents of the fourth processing, in an image including a text image and a photo image in a mixed manner, an image including a photo image having a slightly low degree of glossiness may be achieved. That is, when the image of the document is an image including a text image and a photo image in a mixed manner and a region of the photo image of the document is not glossy, a duplication of the image of the document, in which the degree of glossiness of the text image has not been increased so much and the degree of glossiness of the photo image has been reduced to a slightly low degree, may be achieved.

Next, a case where the document set in the ADF 22 includes only a text image will be described. That is, a case where copying is performed using a document that does not include a photo image at all as the image of the document will be described. For the image of the document, which includes only a text image, the user tends to desire a low degree of glossiness.

Returning to FIG. 5, the user recognizes that the document set in the ADF 22 includes only a text image, and presses down the selection key 62c that is used by the user to set “TEXT IMAGE”. When the digital multifunction peripheral 11 detects the selection key 62c, the digital multifunction peripheral 11 recognizes that a mode of a text image was selected (NO in S13, NO in S19).

Next, after detecting that the start key 32 was pressed down, the digital multifunction peripheral 11 reads out the image of the document set in the ADF 22 by the image reading unit 14. Then, on the basis of the readout image, the digital multifunction peripheral 11 forms a visible image of the toner on the sheet of paper 39 by the image forming unit 15 (S25).

Thereafter, the visible image of the toner is fixed on the sheet of paper 39 by the fixing device 51, and the sheet of paper 39 is discharged to the discharging try 30. In this case, the above-described fixing by the fixing device 51 is performed in accordance with contents of fifth processing considering the image of the document is a text image (S24). The fifth processing is processing of reducing the degree of glossiness to a degree that is lower than the degrees of glossiness in the first to fourth processing. Specifically, each of the temperatures of the heat roller 52 and the pressure roller 54 is set to the first temperature, which the standard temperature. Each of the rotation speeds of the heat roller 52 and the pressure roller 54 is set to the first rotation speed, which is the standard setting. The pressure of contact of the heat roller 52 and the pressure roller 54 is set to the first pressure, which is the standard pressure. Thus, control of the fixing device 51 is performed, and fixing is performed.

By performing the above-described contents of the fifth processing, in an image including only a text image, an image including a text image having a low degree of glossiness may be achieved. That is, when the image of the document is an image including only a text image, a duplication of the image of the document in which the degree of glossiness of the text image has been reduced may be achieved.

That is, the digital multifunction peripheral 11 includes a degree-of-glossiness input unit configured to cause the user to input the degree of glossiness of an output material. Also, in accordance with the degree of glossiness of the output material, which has been input by the degree-of-glossiness input unit, the fixing device 51 is controlled such that the degree of glossiness of the output material is changed. Thus, the degree of glossiness of the output material may be input in accordance with the desire of the user. The fixing device 51 may be controlled so that, in accordance with the degree of glossiness of the output material, which has been input, the degree of glossiness of the output material may be changed. Therefore, the digital multifunction peripheral 11 may form an image that satisfies the desire of the user more.

In this case, the degree-of-glossiness input unit includes the glossy-or-not input unit configured to cause the user to input information on the presence or absence of glossiness in the photo image included in the image formed by the image forming unit 15. Then, the control unit 12 changes the degree of glossiness of the output material in accordance with information on the presence or absence of glossiness in the photo image, which has been input by the glossy-or-not input unit.

Thus, the degree of glossiness of the output material may be changed in accordance with information on the presence and absence of glossiness, which has been input in accordance with the desire of the user. Therefore, an image that satisfies the desire of the user more may be formed.

In this case, the degree-of-glossiness input unit includes a setting unit that causes the user to set information on which one of a photo image, a text image, and an image including a photo image and a text image in a mixed manner an image formed by the image forming unit 15 is. The control unit 12 changes the degree of glossiness of the output material in accordance with the information set by the setting unit.

Thus, the degree of glossiness of the output material may be changed in accordance with information on which one of a photo image, a text image, and an image including a photo image and a text image in a mixed manner, which has been set. Therefore, an image that satisfies the desire of the user more may be formed.

Note that, in the above-described embodiment, the contents of the first processing in fixing indicate that the first processing is processing in which the degree of glossiness is the highest, and the degree of glossiness reduces in the order of the third processing, the second processing, the fourth processing, and the fifth processing.

In this case, the degree of glossiness of the image of the document and the degree of glossiness of a duplicate, which is desired by the user, will be briefly described. FIG. 9 is a graph illustrating the relationship between the desirability of the degree of glossiness required by the user and the degree of glossiness. In FIG. 9, the ordinate axis indicates the desirability of the degree of glossiness, and the higher the desirability is, the greater the number of users that desire the corresponding degree of glossiness is. In FIG. 9, the abscissa axis indicates the degree of glossiness as glossiness, and the glossiness increases towards the right. Note that glossiness is defined in JIS Z 8741 (1997). In this case, it is assumed that the specular reflectivity of a black mirror glass plate having a refractive index of 1.567 is 10% at an incident angle of 60 degrees and this specular reflectivity is a glossiness of 100. In FIG. 9, the line 65a indicates the relationship between the desirability and the glossiness for a so-called glossy image, and the line 65b indicates the relationship between the desirability and the glossiness for a so-called not glossy image.

With reference to FIG. 9, for the so-called glossy image, a peak of the desirability is at around 20 to 27 or 28 of the glossiness, and in contrast, for the so-called not glossy image, the peak of the desirability is at around 15 of the glossiness. That is, it is likely that, for the so-called not glossy image, a relatively low glossiness is desired, as compared to the so-called glossy image. The digital multifunction peripheral 11 having the above-described configuration may satisfy such a desire of the user.

Note that, in the above-described embodiment, a configuration in which, in setting various settings, a normal mode or a gloss mode in which the degree of glossiness is changed relative to the normal mode is selected may be employed. That is, a configuration in which the user is caused to make a selection for control of the fixing device 51, which has been described above, may be employed. Also, a configuration in which the user is made to input the degree of glossiness in the degree-of-glossiness input unit over a plurality of stages may be employed. Also, a configuration which includes a preview image display unit configured to display a preview of an image formed by the image forming unit and in which the degree-of-glossiness input unit changes the degree of glossiness of the output material in accordance with the ratio of the area of a region of a photo image designated from a preview image displayed by the preview image display unit may be employed.

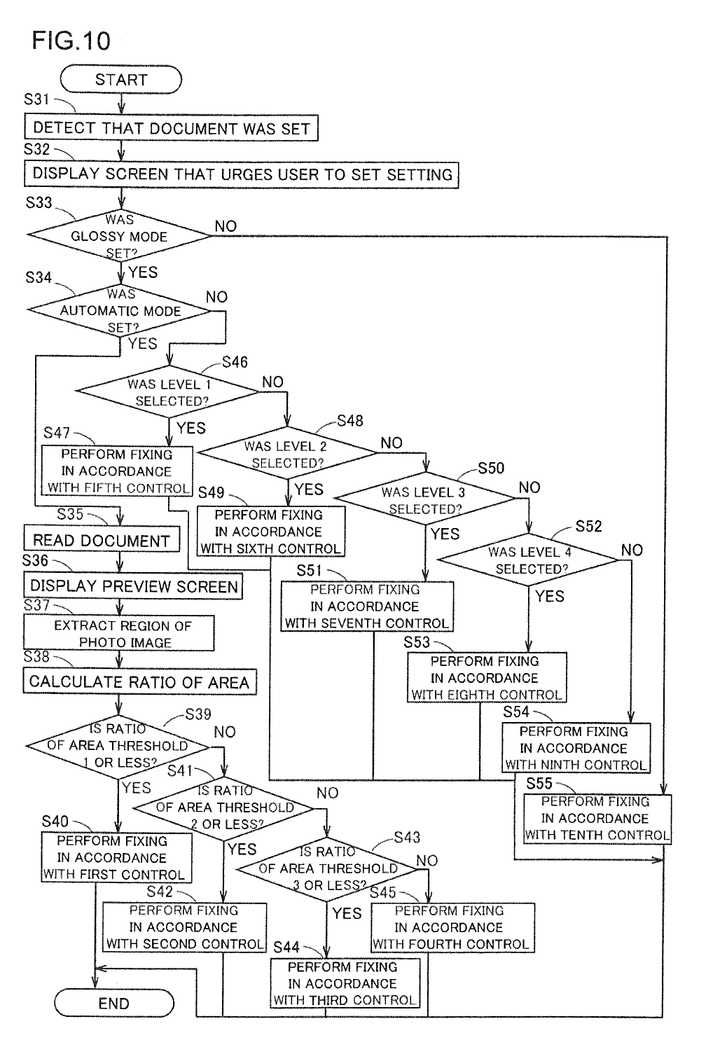

FIG. 10 is a flow chart illustrating contents of processing performed when performing copying using the digital multifunction peripheral 11 according to another embodiment of the present disclosure. In this case, first, a case where the image 67 of the document 66 illustrated in FIG. 8 is read out and copying is performed will be described.

With reference to FIG. 10, when the digital multifunction peripheral 11 detects that a document was set in the ADF 22 (S31), the digital multifunction peripheral 11 displays a screen that urges the user to set various settings in image forming in the display screen 21 of the operation unit 13 (S32).

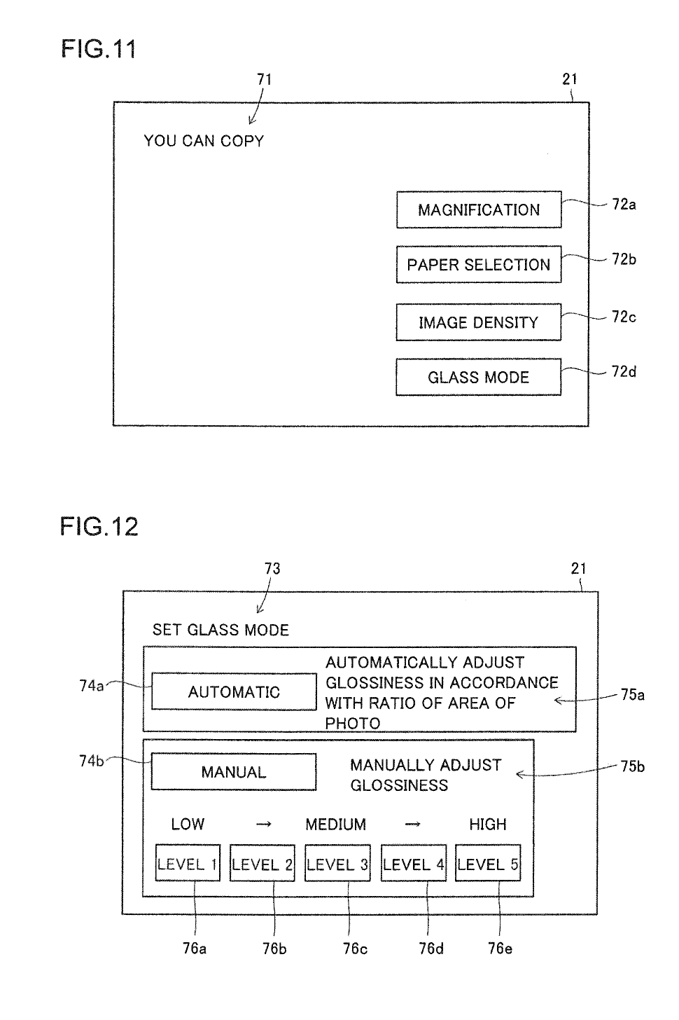

FIG. 11 is a view illustrating an example of the display screen 21 of the operation unit 13 when urging the user to set various settings in image forming With reference to FIG. 11, a message 71 indicating “YOU CAN COPY”, a selection key 72a that indicates “MAGNIFICATION” and is used by the user to set the magnification of the image of the output material for enlargement and reduction for the image of the document, a selection key 72b that indicates “PAPER SELECTION” and is used by the user to select a sheet of paper stored in the paper cassettes 23a, 23b, and 23c, which is to be output, a selection key 72c that indicates “IMAGE DENSITY” and is used by the user to set the density of an image that is to be output, and a selection key 72d that indicates “GLOSS MODE” and is used by the user to set the degree of glossiness of the output material are displayed in the display screen 21 of the operation unit 13 included in the digital multifunction peripheral 11 according to this another embodiment. The user presses down the selection keys 72a, 72b, and 72c to set the magnification, select a sheet of paper, and set the image density, in accordance with the desire of the user.

If the user desires to change the degree of glossiness, the user presses down the selection key 72d indicating “GLOSS MODE. When the digital multifunction peripheral 11 detects that the selection key 72d was pressed down (YES in S33), the digital multifunction peripheral 11 causes the user to set whether the degree of glossiness as the gloss mode is to be changed automatically, or manually, that is, in accordance with the level of glossiness designated by the user (S34).

FIG. 12 is a view illustrating an example of the display screen 12 of the operation unit 13 when making the user to set the gloss mode. With reference to FIG. 12, a message 73 indicating “SET GLOSS MODE”, a selection key 74a that indicates “AUTOMATIC” and causes automatic adjustment of the degree of glossiness to be performed in accordance with the ratio of the area of a photo image to be performed, a message 75a indicating “AUTOMATICALLY ADJUST DEGREE OF GLOSSINESS IN ACCORDANCE WITH RATIO OF AREA OF PHOTO IMAGE”, which describes contents that are to be executed by pressing down the selection key 74a, a selection key 74b that indicates “MANUAL” and causes the user input the degree of glossiness, a message 75b indicating “MANUALLY ADJUST DEGREE OF GLOSSINESS”, which describes contents that are to be executed by pressing down the selection key 74b, a selection key 76a indicating “LEVEL 1”, a selection key 76b indicating “LEVEL 2”, a selection key 76c indicating “LEVEL 3”, a selection key 76d indicating “LEVEL 4”, and a selection key 76e indicating “LEVEL 5”, which are used by the user to set the degree of glossiness over five stages, are displayed in the display screen 21. As for the selection keys 76a to 76e, the degree of glossiness that may be set by pressing down the selection keys 76a to 76e increases in the order of the selection key 76a, the selection key 76b, the selection key 76c, the selection key 76d, and the selection key 76e.

In this case, a case where the user selects an automatic mode, that is, automatically changing the degree of glossiness, will be described. When the digital multifunction peripheral 11 detects that the selection key 74a was pressed down and then detects that the start key 32 was pressed down (YES in S34), the digital multifunction peripheral 11 starts reading the document (S35). Thereafter, a preview image is displayed in the display screen 21 (S36). In this case, the preview image of the image 67 of the document 66 illustrated in FIG. 8, which has been described above, is displayed.

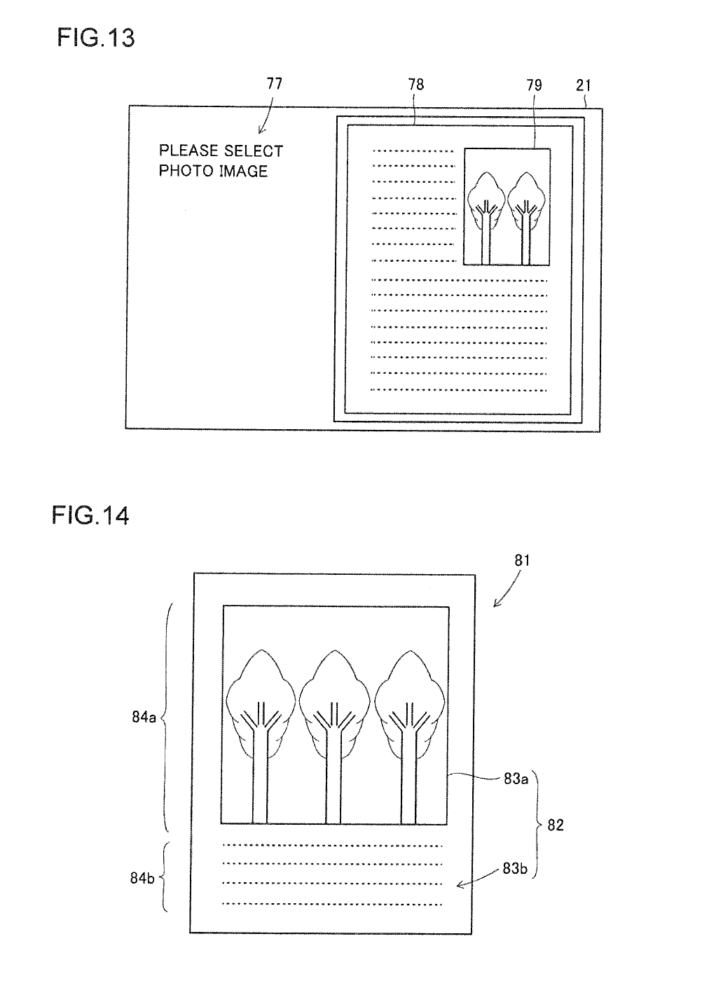

FIG. 13 is a view illustrating an example of the display screen 21 when the image 67 of the document 66 illustrated in FIG. 8 has been read out and previewed. With reference to FIG. 13, a message 77 indicating “PLEASE SELECT PHOTO IMAGE” and a preview display image 78 as a preview of the image 67 of the document 66 are displayed in the display screen 21. A photo image 79 corresponding to the photo image 68a included in the image 67 of the document 66 is displayed in the preview display image 78. The user selects a region of the photo image 79 from the preview display image 78. In this case, for example, in the display screen 21 of a touch panel type, a region of the photo image 79 is pressed down by the user, and thus, it is detected that the photo image 79 was selected. Thereafter, the digital multifunction peripheral 11 extracts the region of the selected photo image 79 (S37), and the ratio of the area of the photo image 79 to the entire image is calculated (S38). For the image 67 of the document 66 illustrated in FIG. 8, the photo image 68a occupies about one fourth of the entire image, and accordingly, the ratio of the area of the photo image 68a is about 25% of the area of the entire image.

Next, the calculated ratio of the area is compared to a threshold, which has been set in advance (S39). That is, if the calculated ratio of the area is relatively small and is equal to or smaller than a threshold 1, which is a value set as a threshold (YES in S39), fixing is performed in accordance with first control (S40). In this embodiment, for example, 30% is set as the value of the threshold 1. The first control in this case is control of fixing in which the degree of glossiness is relatively low, as compared to a photo image. Specifically, while each of the temperatures of the heat roller 52 and the pressure roller 54 and the rotation speeds of the heat roller 52 and the pressure roller 54 is kept standard, fixing is performed such that the pressure of contact of the heat roller 52 and the pressure roller 54 is set a relatively high pressure in a region 69a in which a text image and a photo image are arranged in line and the pressure of contact of the heat roller 52 and the pressure roller 54 is set to the standard pressure in a region 69b including only a text image.

In this case, as an image 82 of a document 81 illustrated in FIG. 14, if a region occupied by a photo image 83a is greater than a region occupied by the photo image 68a illustrated in FIG. 8, the calculated ratio of the area is greater than the threshold 1 (NO in S39). FIG. 14 is a view illustrating the image 82 of the document 81 in which a region occupied by the photo image 83a is relatively large. Thus, it is determined whether or not the calculated ratio of the area is a threshold 2, which is set as a threshold, or less (S41). In this embodiment, for example, 60% is set as the value of the threshold 2. If the calculated ratio of the area is equal to or lower than the threshold 2 (YES in S41), fixing is performed in accordance with second control (S42). The second control in this case is control of fixing in which the degree of glossiness is higher than that in fixing performed in accordance with the above-described first control. Specifically, while each of the temperatures of the heat roller 52 and the pressure roller 54 and the pressure of contact of the heat roller 52 and the pressure roller 54 is kept standard, fixing is performed such that each of the rotation speeds of the heat roller 52 and the pressure roller 54 is set to be relatively low in a region 84a including only the photo image 83a and each of the rotation speeds of the heat roller 52 and the pressure roller 54 is set to the standard rotation speed in a region 84b including only a text image 83b. In this case, unlike the case illustrated in FIG. 8, the region 84a is larger and the region 84b is smaller.

On the other hand, if it is determined that the calculated ratio of the area is greater than the value set as the threshold 2 (NO in S41), it is further determined whether or not the ratio is equal to or lower than a threshold 3, which has been set in advance (S43). In this embodiment, for example, 90% is set as a value of the threshold 3. If the calculated ratio of the area is equal to or lower than the threshold 3 (YES in S43), fixing is performed in accordance with third control (S44). The third control in this case is control of fixing in which the degree of glossiness is higher than that in fixing performed in accordance with the above-described second control. Specifically, while each of the temperatures of the heat roller 52 and the pressure roller 54 is kept standard, fixing is performed such that each of the rotation speeds of the heat roller 52 and the pressure roller 54 is set to be relatively low and the pressure of contact thereof is set to be high in the region 69a in which a text image and a photo image are arranged in line, and each of the rotation speeds of the heat roller 52 and the pressure roller 54 is set to the standard rotation speed and the pressure of contact thereof is set to the standard pressure in the region 69b including only a text image.

Note that, in S43, if it is determined that the calculated ratio of the area is greater than the threshold 3 (NO in S43), fixing is performed in accordance with fourth control (S45). The fourth control in this case is control of fixing in which the degree of glossiness is higher than that in fixing performed in accordance with the above-described third control. Specifically, while each of the temperatures of the heat roller 52 and the pressure roller 54 is set to be higher than the standard temperature, fixing is performed such that each of the rotation speeds of the heat roller 52 and the pressure roller 54 is set to the standard rotation speed and the pressure of contact thereof is set to be high in the region 69a in which a text image and a photo image are arranged in line, and each of the rotation speeds of the heat roller 52 and the pressure roller 54 is set to the standard rotation speed and the pressure of control thereof is set to the standard pressure.

Thus, for example, the degree of glossiness of the output material may be set high when the ratio of the area of the region of the photo image is large, and may be set low when the ratio of the area of the region of the photo image is small by selecting the gloss mode and also selecting the automatic mode. Therefore, an image that satisfies the desire of the user more may be formed.

Next, returning to S34, a case where the automatic mode is not selected and the manual mode is selected will be described. The user presses down the selection key 74b of the manual mode. After pressing down the selection key 74b, the user presses down the selection keys 76a to 76e. In this case, when the digital multifunction peripheral 11 detects that the selection key 74b was pressed down, the digital multifunction peripheral 11 may continuously perform display that urges the user to press down one of the selection keys 76a to 76e.

When the digital multifunction peripheral 11 detects that the selection key 74b was pressed down (NO in S34), the digital multifunction peripheral 11 determines whether or not one of the selection keys 76a to 76e was pressed down. In this case, if the digital multifunction peripheral 11 detects that the selection key 76a was pressed down (YES in S46), the digital multifunction peripheral 11 determines that LEVEL 1 with which the degree of glossiness is set to be the lowest was selected. Thus, fixing is performed in accordance with the fifth control in which the degree of glossiness is the lowest (S47). Specific control of fixing in this case is, for example, similar control to the above-described first control.

When the digital multifunction peripheral 11 detects that the selection key 76b was pressed down (NO in S46, YES in S48), the digital multifunction peripheral 11 determines that LEVEL 2 with which the degree of glossiness is set to be higher than that set with LEVEL 1 was selected. Then, fixing is performed in accordance with sixth control in which the degree of glossiness is set to be slightly higher than that in the fifth control (S49). Specific control of fixing in this case is, for example, similar control to the above-described second control.

When the digital multifunction peripheral 11 detects that the selection key 76c was pressed down (NO in S48, YES in S50), the digital multifunction peripheral 11 determines that LEVEL 3 with which the degree of glossiness is set to be higher than that set with LEVEL 2 was selected. Then, fixing is performed in accordance with seventh control in which the degree of glossiness is set to be slightly higher than that in the sixth control (S51). Specific control of fixing in this case is, for example, similar control to the above-described third control.

When the digital multifunction peripheral 11 detects that the selection key 76d was pressed down (NO in S50, YES in S52), the digital multifunction peripheral 11 determines that LEVEL 4 with which the degree of glossiness is set to be higher than that set with LEVEL 3 was selected. Then, fixing is performed in accordance with eighth control in which the degree of glossiness is set to be slightly higher than that in the seventh control (S53). Specific control of fixing in this case is, for example, similar control to the above-described fourth control.

When the digital multifunction peripheral 11 detects that the selection key 76e was pressed down (NO in S52), the digital multifunction peripheral 11 determines that LEVEL 5 with which the degree of glossiness is set to be the highest was selected. Then, fixing is performed in accordance with ninth control in which the degree of glossiness is set to be slightly higher than that in the eighth control (S54). Specific control of fixing in this case is, for example, control in which, while each of the temperatures of the heat roller 52 and the pressure roller 54 is set to be higher than the standard temperature, fixing is performed such that each of the rotation speeds of the heat roller 52 and the pressure roller 54 is set to be lower than the standard rotation speed and the pressure of contact thereof is set to be high in the region 69a in which a text image and a photo image are arranged in line and each of the rotation speeds of the heat roller 52 and the pressure roller 54 is set to the standard rotation speed and the pressure of the contact thereof is set to the standard pressure in the region 69b including only a text image.

With the above-described configuration, the degree of glossiness of the output material may be changed over an increased number of stages by selecting the gloss mode and also selecting the manual mode. Thus, an image that satisfies the desire of the user more may be formed.

Note that, returning to S33, if the gloss mode is not selected by the user (NO in S33), input of the degree of glossiness is not performed. Then, image forming is performed in the normal mode. In this case, as fixing in accordance with tenth control, standard fixing is performed (S55). That is, as fixing in accordance with the tenth control, fixing is performed such that each of the temperatures of the heat roller 52 and the pressure roller 54, the rotation speeds of the heat roller 52 and the pressure roller 54, and the pressure of contact of the heat roller 52 and the pressure roller 54 is set to the corresponding standard setting.

As described above, the degree of glossiness may be changed in accordance with the desire of the user by making the user to select whether or not the gloss mode is to be operated.

Note that, although, in this embodiment, the degree of glossiness is changed over four stages in total, that is, stages of the threshold 1 or lower, the threshold 2 or lower, the threshold 3 or lower, and a value higher than the threshold 3, the manner in which the degree of glossiness is changed is not limited thereto, and the degree of glossiness may be changed over two stages, three stages, or, of course, five or more stages. Also, in the manual mode, although, in this embodiment, the degree of glossiness is changed over five stages, that is, stages of LEVEL 1 to LEVEL 5, the manner in which the degree of glossiness is changed is not limited thereto, and the degree of glossiness may be changed over two stages, three stages, four stages, or, furthermore, six or more stages.

Note that, although, in the above-described embodiment, the degree of glossiness is changed in accordance with control of the fixing device, the degree of glossiness may be changed in accordance with control of the image forming unit. In this case, for example, a developing bias voltage in developing in the image forming unit is adjusted to change the degree of glossiness. Specifically, when a visible image is formed, the developing bias voltage is changed to slightly increase the amount of the toner attached to an electrostatic latent image formed on a surface of a photoreceptor, and control is performed to slightly increase glossiness. In this case, as a matter of course, the image density may be set in accordance with the amount of the attached toner, which allows faithful reproduction of the image of the document.

Also, in the above-described embodiment, the disclosed technique is not limited to application to copying of an image of a black-and-white document, and the like, and may be, as a matter of course, applied to a case where copying of an image of a color document, and the like, is performed. In this case, a configuration in which an intermediate transfer medium, such as a transfer belt, may be employed.

Note that, although, in the above-described embodiment, an amount by which the degree of glossiness of an output material may be increased by setting the temperatures of the heat roller 52 and the pressure roller 54, the rotation speeds of the heat roller 52 and the pressure roller 54, and the pressure of contact of the heat roller 52 and the pressure roller 54 increases in the order of the temperatures of the heat roller 52 and the pressure roller 54, the rotation speeds of the heat roller 52 and the pressure roller 54, and the pressure of contact of the heat roller 52 and the pressure roller 54, the order is not limited thereto, and, as a matter of course, the order may be changed, depending on settings of the temperatures, the rotation speeds, and the like.

The embodiments and examples disclosed herein are provided merely for illustrative purpose in every respect and are not intended to be limiting in any aspect. The scope of the present disclosure is defined by the scope of claims rather than the above-described description, and is intended to include any modifications within the scope and meaning equivalent to the terms of the claims.

In particular, an image forming apparatus according to the present disclosure is effectively used when image forming in accordance with a desire of a user is required.

What is claimed is:

1. An image forming apparatus comprising:
an image forming unit including a developing device configured to perform development to form, on the basis of image data, a visible image of a toner on a sheet of paper;
a fixing device including a pair of rollers that contact each other and configured to convey the sheet of paper on which the visible image is formed by the image forming unit to between the pair of rollers, fix the visible image on the sheet of paper by heat and pressure, and output the sheet of paper as an output material;
a degree-of-glossiness input unit configured to cause a user to input the degree of glossiness of the output material; and
a control unit configured to control at least one of the fixing device and the image forming unit to change the degree of glossiness of the output material in accordance with the degree of glossiness of the output material, which was input by the degree-of-glossiness input unit.

2. The image forming apparatus according to claim 1,
wherein the degree-of-glossiness includes a glossy-or-not input unit configured to cause the user to input information on the presence or absence of glossiness in a photo image included in an image formed by the image forming unit, and
the control unit changes the degree of glossiness of the output material in accordance with the information on the presence or absence of glossiness in the photo image, which was input by the glossy-or-not input unit.

3. The image forming apparatus according to claim 1,
wherein the degree-of-glossiness input unit includes a setting unit configured to cause the user to set information on which one of a photo image, a text image, and an image including a photo image and a text image in a mixed manner an image formed by the image forming unit is.

4. The image forming apparatus according to claim 1,
wherein the degree-of-glossiness input unit is configured to cause the user to input the degree of glossiness of the output material over a plurality of stages.

5. The image forming apparatus according to claim 1, further comprising:
a preview image display unit configured to display a preview of an image formed by the image forming unit,
wherein the degree-of-glossiness input unit changes the degree of glossiness of the output material in accordance with the ratio of the area of a region of the photo image designated in the preview image displayed by the preview image display unit.

6. The image forming apparatus according to claim 1, further comprising:
a selection unit configured to cause the user to select whether or not control by the control unit is to be operated.

7. The image forming apparatus according to claim 1,
wherein the control unit controls at least one of temperatures of the pair of rollers, rotation speeds of the pair of rollers, pressure of contact of the pair of rollers, and adjustment of a developing bias in the developing device.
